(19) United States
(12) Patent Application Publication
(10) Pub. No.: US 2011/0296376 A1
(43) Pub. Date: Dec. 1, 2011

(54) Dynamically Injecting Behaviors Into Flex View Components

(75) Inventors: Joseph Weizhen HU, Lexington, MA (US); Rahul Singhai, Pune (IN); Vaibhav Subhash Joshi, Pune (IN)

(73) Assignee: Sybase, Inc., Dublin, CA (US)

(21) Appl. No.: 12/787,888

(22) Filed: May 26, 2010

(51) Int. Cl. G06F 9/44

(52) U.S. Cl. 717/110

(57) ABSTRACT

Systems, methods and articles of manufacture for dynamically injecting behaviors into view components are described herein. In an embodiment, a view component resides in an MXML file, while its behavior code (e.g., ACTIONSCRIPT) is stored in a separate file (e.g., .as file). In this way, the view component can be reused in separate applications where different behaviors may be applied to the same view component. In addition, because the behavior code is stored in a separate file, the behavior code is easier to read and maintain. Furthermore, behaviors can be dynamically (i.e., at runtime) injected into and un-injected from the view component. Embodiments of the invention also allow multiple behaviors to be injected into the same view component.

### BACKGROUND

1. Field

Embodiments of the present invention generally relate to graphical user interface (GUI) development.

2. Background Art

FLEX is a software development kit released by Adobe Systems for the development and deployment of cross-platform Internet applications. FLEX provides a workflow and programming model that is based on Macromedia Extensible Mark-up Language (MXML). MXML is based on the Extensible Mark-up Language (XML) and offers a way to build and lay out GUIs.

In GUI applications developed using FLEX, code that is responsible for the behavior of a view component is typically coded as part of the view component. This makes it extremely difficult to reuse the same view component in another application context, where different application behaviors may apply.

Accordingly, systems, methods and articles of manufacture are needed that overcome limitations of conventional FLEX development approaches and allow view components to be efficiently reused.

### BRIEF SUMMARY

Embodiments of the present invention relate to dynamically injecting behaviors into view components. In an embodiment, a view component resides in an MXML file, while its behavior code (e.g., ACTIONSCRIPT) is stored in a separate file (e.g., .as file). In this way, the view component can be reused in separate applications where different behaviors may be applied to the same view component.

In addition, because the behavior code is stored in a separate file, the behavior code is easier to read and maintain, and otherwise access and utilize. Furthermore, behaviors can be dynamically (i.e., at runtime) injected into and un-injected from the view component. Embodiments of the invention also allow multiple behaviors to be injected into the same view component.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form a part of the specification, illustrate embodiments of the present invention and, together with the description, further serve to explain the principles of the invention and to enable a person skilled in the relevant art to make and use the invention.

FIG. 1A illustrates an exemplary system for behavior injection, according to an embodiment.

FIG. 1B illustrates an exemplary behavior injection class diagram, according to an embodiment.

FIG. 2A illustrates an exemplary user interface screen, according to an embodiment.

FIG. 2B illustrates the screen of FIG. 2A, after an user interface element has been selected, according to an embodiment.

FIG. 2C illustrates the screen of FIG. 2A, after another user interface element has been selected, according to an embodiment.

FIG. 3A illustrates an exemplary user interface screen that is represented by a view component.

FIG. 3B illustrates another exemplary user interface screen that is represented by the view component of FIG. 3A.

FIG. 4 is a flowchart illustrating a behavior injection and un-injection operation, according to an embodiment.

FIG. 5 depicts an example computer system in which embodiments of the present invention may be implemented.

The present invention will now be described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

The following detailed description of the present invention refers to the accompanying drawings that illustrate exemplary embodiments consistent with this invention. Other embodiments are possible, and modifications can be made to the embodiments within the spirit and scope of the invention. Therefore, the detailed description is not meant to limit the invention. Rather, the scope of the invention is defined by the appended claims.

It would be apparent to one of skill in the art that the present invention, as described below, can be implemented in many different embodiments of software, hardware, firmware, and/or the entities illustrated in the figures. Any actual software code with the specialized control of hardware to implement the present invention is not limiting of the present invention. It is to be appreciated that embodiments of the present invention are not limited to ADOBE FLEX, ACTIONSCRIPT, and MXML. Instead, embodiments of the invention are applicable and can be used with other user interface development platforms and languages. Thus, the operational behavior of embodiments of the present invention will be described with the understanding that modifications and variations of the embodiments are possible, and within the scope and spirit of the invention.

### Overview of FLEX

As discussed earlier, FLEX is a software development kit for the development and deployment of cross-platform Internet applications. As noted above, while embodiments of the invention are described herein with reference to FLEX, such description is provided for purposes of illustration, not limitation. Embodiments of the invention are applicable and can be used with other user interface development platforms and languages, now existing or developed in the future.

The FLEX language includes a rich library of user interface components, MXML (an XML-based markup language), and ACTIONSCRIPT (an object-oriented programming language). The FLEX language capitalizes on the strengths of two popular development paradigms: markup languages and object-oriented programming languages. MXML is used to declaratively set up a user interface and other aspects of an application and ACTIONSCRIPT provides behavior logic which handles user interactions with the application. FLEX can enable developers to build large-scale applications that leverage the Flash platform.

The FLEX language is event driven. MXML exposes events as tag attributes where a developer can write script event handlers. For example, a ‘Button’ component can have a ‘Click’ attribute. For simple interactions, developers can write script statements directly in a tag attribute for an event. When behavior logic is more complex, developers can define a script function embedded within MXML code and call that function from a component event handler as shown in conventional Example 1 below.

Example 1 shown below, outlines an exemplary MXML code (or document). Referring to Example 1, code that appears between lines (1.1) and (1.2) includes behavior script (e.g., ACTIONSCRIPT) that is configured to perform the functions ‘OnSaveClick’ and ‘on CancelClick’ whenever these functions are called. The script is encapsulated by the <mx:Script> and </mx:Script> MXML tags. Certain user interface components (e.g., FormItem) are also defined between lines (1.3) and (1.4) and lines (1.5) and (1.6) respectively. Line (1.7) defines a ‘Button’ labeled ‘Save’ that calls the function ‘OnSaveClick’ when the ‘Save’ button is clicked. Line (1.8) defines a ‘Button’ labeled ‘Cancel’ that calls the function ‘OnCancelClick’ when the ‘Cancel’ button is clicked.

<?xml version=″1.0″ encoding=″utf-8″?>
<mx:Panelxmlns:mx=″http://www.adobe.com/2006/mxml″
layout=″vertical″ >

| | |
|---|---|
| <mx:Script> | (1.1) |

<![CDATA[

private function onSaveClick( ):void{

Alert.show(″Save button clicked.″);

}
private function onCancelClick( ):void{

Alert.show(″Cancel button clicked.″);

}

]]>

| | |
|---|---|
| </mx:Script> | (1.2) |
| <mx:FormItem label=″First Name:″ required=″true″> | (1.3) |

<mx:TextInput id=″firstName″ width=″300″/>

| | |
|---|---|
| </mx:FormItem> | (1.4) |
| <mx:FormItem label=″Last Name:″ required=″true″> | (1.5) |

<mx:TextInput id=″lastName″ width=″300″/>

| | |
|---|---|
| </mx:FormItem> | (1.6) |
| <mx:FormItem> | |

<mx:HBox>

| | |
|---|---|
| <mx:Button id=″btnSave″ label=″Save″ | (1.7) |
| onClick=″onSaveClick″/> | |

<mx:Button id=″btnCancel″ label=″Cancel″

| | |
|---|---|
| onClick=”onCancelClick”/> | (1.8) |

</mx:HBox>

</mx:FormItem>

</mx:Panel>

### Example 1

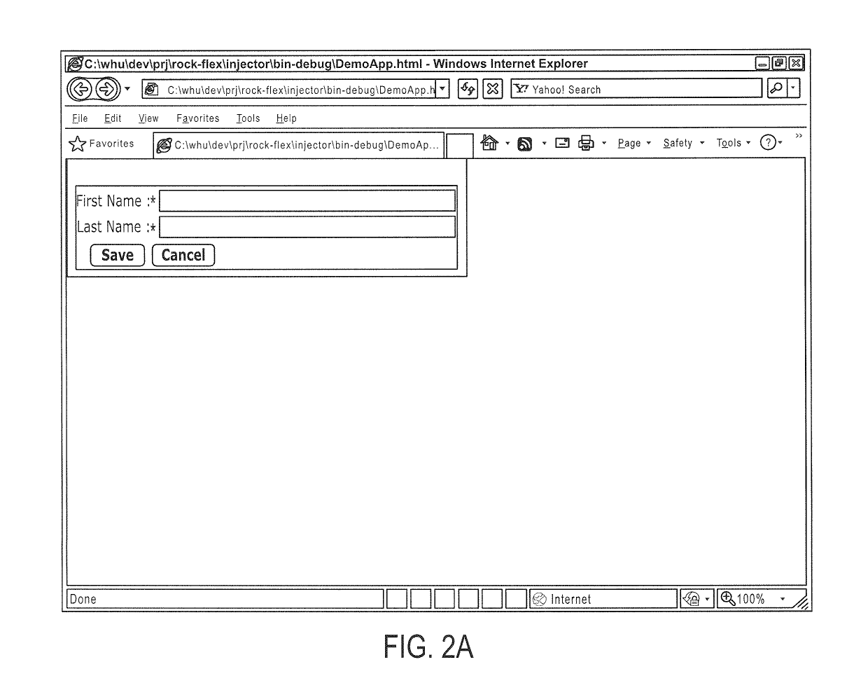

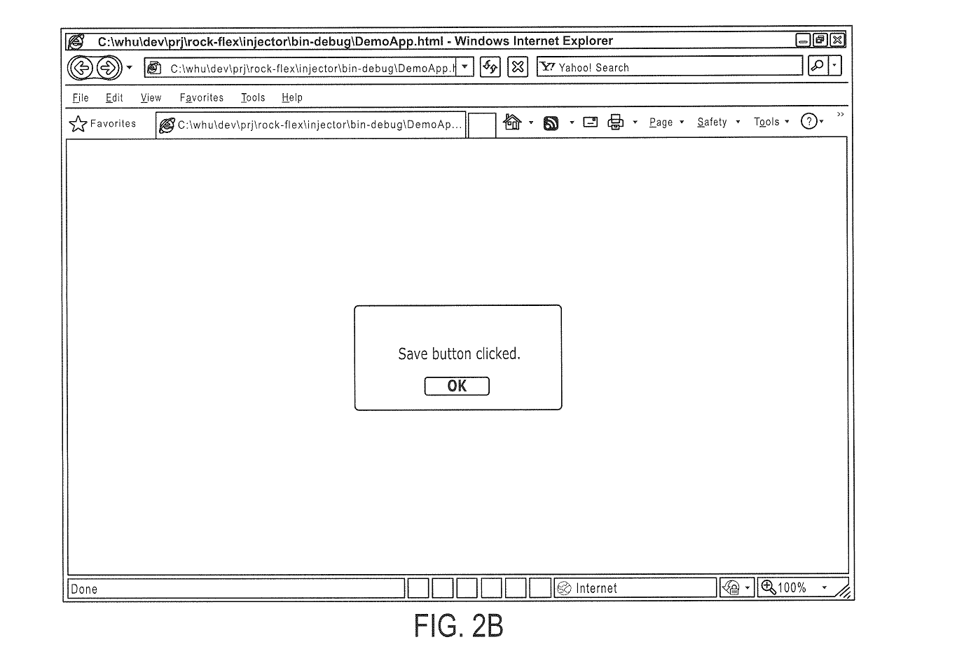

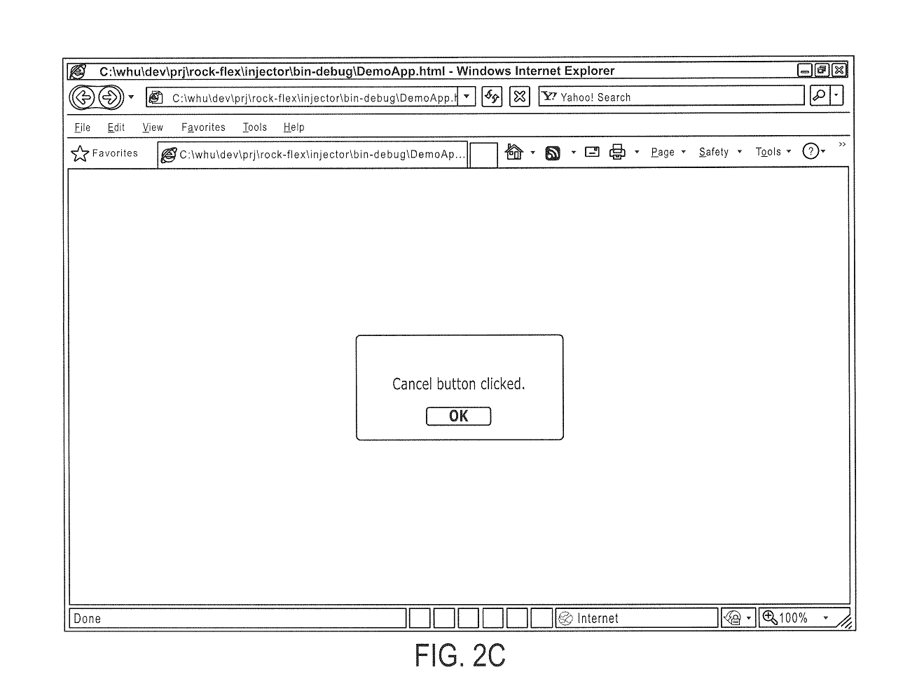

FIG. 2A illustrates an exemplary screen ‘MyView’. FIG. 2B illustrates the view of FIG. 2A after a ‘Save’ button has been clicked. Referring to Example 1, when the ‘Save’ button is clicked, the ‘onSaveClick’ function is called which displays the text “Save button clicked,” as shown in FIG. 2B.

FIG. 2C illustrates the screen of FIG. 2A after a ‘Cancel’ button has been clicked.

Referring to Example 1, when the ‘Cancel’ button is clicked, the ‘on CancelClick’ function is called which displays the text “Cancel button clicked” as shown in FIG. 2C.

In the conventional MXML Example 1 shown above, the ‘onSaveClick’ and ‘on CancelClick’ behaviors are hardwired (or permanently linked) to their respective view components (i.e., btnSave and btnCancel view components respectively). Thus, it is not possible for a view component (e.g., ‘btnSave’) to be reused in a different application context that requires different behaviors from the view component.

In contrast to conventional approaches, embodiments of the present invention allow behavior code to be separated from their associated view components. In an embodiment, a view component resides in an MXML file, while its behavior code (e.g., ACTIONSCRIPT) is stored in a separate file (e.g., .as file). In this way, the view component can be reused in separate applications where different behaviors may be applied to the same view component.

Furthermore, as will be discussed below, behaviors can be dynamically (i.e., at runtime) injected into and un-injected from the view component. Embodiments of the invention also allow multiple behaviors to be injected into the same view component.

### System

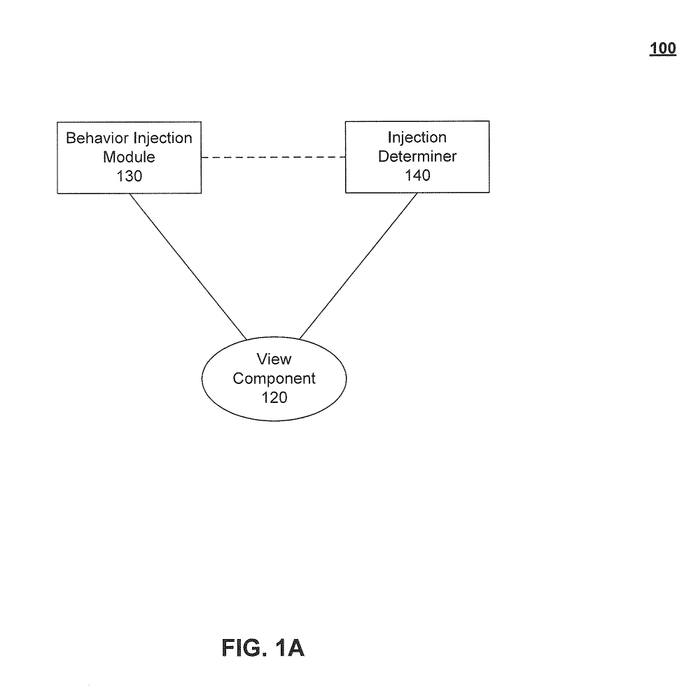

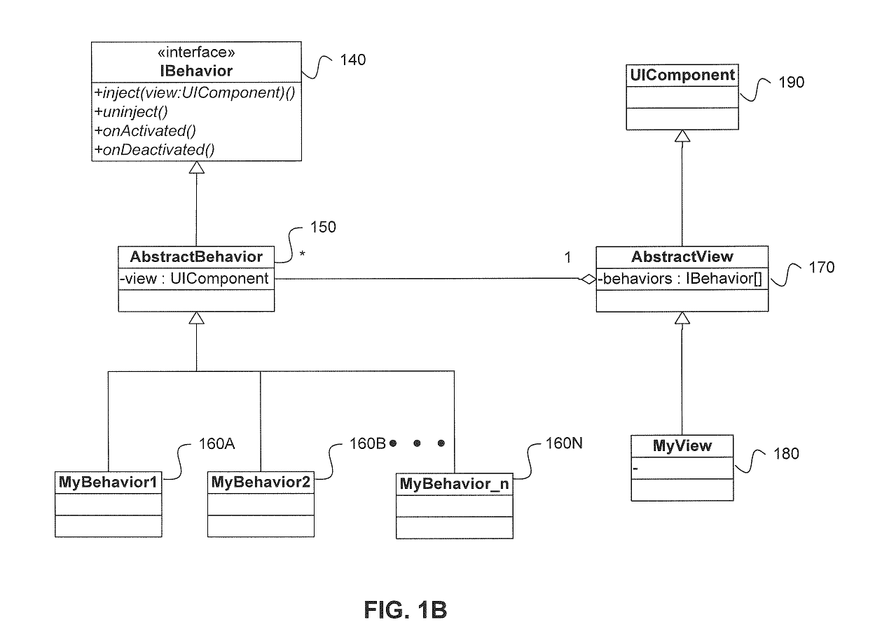

FIG. 1A illustrates system 100, according to an embodiment of the invention. FIG. 1A includes view component 120, behavior injection module 130, and injection determiner 140.

In an embodiment, view component 120 can be any user interface component (hidden or displayed). A view component can include any application view component (or user interface element). As a purely illustrative example, a view component can be as complex as an application screen (e.g., MyView), or as simple as a widget (e.g., btnSave).

In an embodiment, behavior injection module 130 is configured to inject (or embed) one or more behaviors into view component 120. In an embodiment, not intended to limit the invention, such injection can occur when view component 120 is initialized by an application. Furthermore, behavior injection module 130 can un-inject (or remove) one or more behaviors (that may have been previously injected into view component 120) when view component 120 is no longer active or displayed.

As a purely illustrative example, not intended to limit the invention, a view component is initialized when the view component is created for the first time (e.g., initially instantiated). A view component can be ‘destroyed’, for example, when the component is made out of scope of memory (or made no longer resident in memory). For example, when a user closes a user interface dialog, the dialog is destroyed or removed from memory. In an embodiment, when a view component is activated, the view component it is made visible or displayed. Conversely, in an embodiment, when a view component is de-activated, it is hidden from display. When a view component is de-activated, for example, the view component may continue to be resident in system memory (or storage). As a purely illustrative example, not intended to limit the invention, once a view component has been initialized, the view component can be activated (displayed) and de-activated (hidden from display) one or more times. In a non-limiting example, a view component can be activated or de-activated as default, upon its initialization, based on pre-configured settings.

In an embodiment, behaviors can be injected by behavior injection module 130 when a view component is being initialized, and un-injected when the component is destroyed. In another embodiment, behaviors can be injected by behavior injection module 130 during activation and un-injected after de-activation of a view component. Furthermore, for example, when a new instance of UI component is created (e.g., a UI component belonging to the same parent class), the new instance initialized, and behaviors can be injected by behavior injection module 130.

In an embodiment, injection determiner 140 is configured to determine when a view component has been activated (i.e., displayed) and when a view component has been de-activated (i.e., hidden from display). In another non-limiting embodiment, injection determiner 140 is configured to determine when a view component has been activated (i.e., displayed) for the first time and when a view component has been de-activated (i.e., hidden from display). Injection determiner 140 informs behavior injection module 130 that a view component 120 has been activated so that behavior injection module 130 can inject an appropriate behavior(s) associated with view component 120. In a similar manner, injection determiner 140 informs behavior injection module 130 that a view component 120 has been de-activated so that behavior injection module 130 can un-inject an injected behavior from view component 120.

In an embodiment, not intended to limit the invention, behavior injection module 130 and injection determiner 140 can be implemented using one or more processors. Furthermore, in an embodiment, behavior injection module 130 and injection determiner 140 can each include one or more processor based modules configured to perform one or more of the operations discussed herein. Although FIG. 1A illustrates a single behavior injection module 130, view component 120 and injection determiner 140, it is to be appreciated that system 100 is scalable and can be configured to operate with any number of behavior injection modules, view components or injection determiners.

FIG. 1B illustrates an exemplary behavior injection class diagram, according to an embodiment.

As illustrated in FIG. 1B, an exemplary behavior injection class diagram includes, but is not limited to, the following components:

### A. Interface Behavior

In an embodiment, all behavior classes implement an interface behavior such as interface behavior 140. In an embodiment interface behavior 140 can be implemented as an ‘.as’ file known as ‘IBehavior.as’.

In an embodiment, interface behavior 140 defines the following interface methods.

i. inject (view: UIComponent): Called to inject one or more behaviors into a view component. An inject interface method is typically called when a view (e.g., MyView) is initialized. As an example, behavior injection module 130 can call an inject interface method.

ii. uninject( ): Called to un-inject (or remove) an injected behavior from a view component. An un-inject interface method is typically called when a view (e.g., MyView) is destroyed (e.g., removed from memory). As an example, behavior injection module 130 can call an un-inject interface method.

iii. onActivated( ): Called each time a view is activated (or displayed). As an example, injection determiner 140 can call an ‘onActivated’ interface method if injection determiner 140 determines that a view (e.g., MyView) has been activated (e.g., activated for the first time).

iv. onDeactivated( ): Called each time an activated view is de-activated (or hidden from display). As an example, injection determiner 140 can call an ‘onDeactivated’ interface method if injection determiner 140 determines that an activated view (e.g., MyView) has been de-activated.

### B. Abstract Behavior

In an embodiment, abstract behavior 150 acts as a base class for all behavior classes. In an embodiment, abstract behavior 150 can be implemented as an ‘.as’ file known as ‘AbstractBehavior.as’, which acts as base class for all behavior classes. In an embodiment, and as shown in FIG. 1B, abstract behavior 150 contains a member ‘view’, which is set when inject(view:UIComponent) is called.

### C. Behavior Implementation Classes

In an embodiment, behavior classes 160A-N include behavior code or script. As an example, not intended to limit the invention, such behavior code can be implemented in ACTIONSCRIPT. In an embodiment, if a view component involves a complex behavior, such complex behavior can be divided into several behavior classes, all of which can be injected by behavior injection module 130 into the same view component.

### D. Abstract View

In an embodiment, abstract view 170 acts as a base class for all view components. In an embodiment, abstract view 170 includes an array (or any other data structure) of ‘IBehavior’ objects. In an embodiment, when one or more behaviors are injected into a view component by behavior injection module 130, the behaviors are stored in the array of ‘IBehavior’ objects. Because the behaviors are stored into an array, behavior injection module 130 (or injection determiner 140) can check the array before injecting behaviors into a view component. Such operation can ensure that no behavior is injected twice into the same view component. Furthermore, storage of behaviors in an array allows behavior injection module 130 to automatically unwind (or remove) all behaviors from the view component when the view component (or its encapsulating user interface screen) is destroyed (e.g., removed from memory).

### E. View Components

In an embodiment, view component 180 can be constructed using MXML. As shown in FIG. 1B, view component 180 is ‘MyView’. As shown in FIG. 1B, ‘MyView’ represents a user interface view screen. In an embodiment, view component 180 (e.g., ‘MyView’) can be used to represent different screens of a user interface. A behavior injection class diagram can also include one or more UI components 190. Such UI components can include user interface elements (e.g., buttons, selection boxes, forms, etc.) that inherit behaviors from a behavior array in abstract view 170.

### Behavior Injection

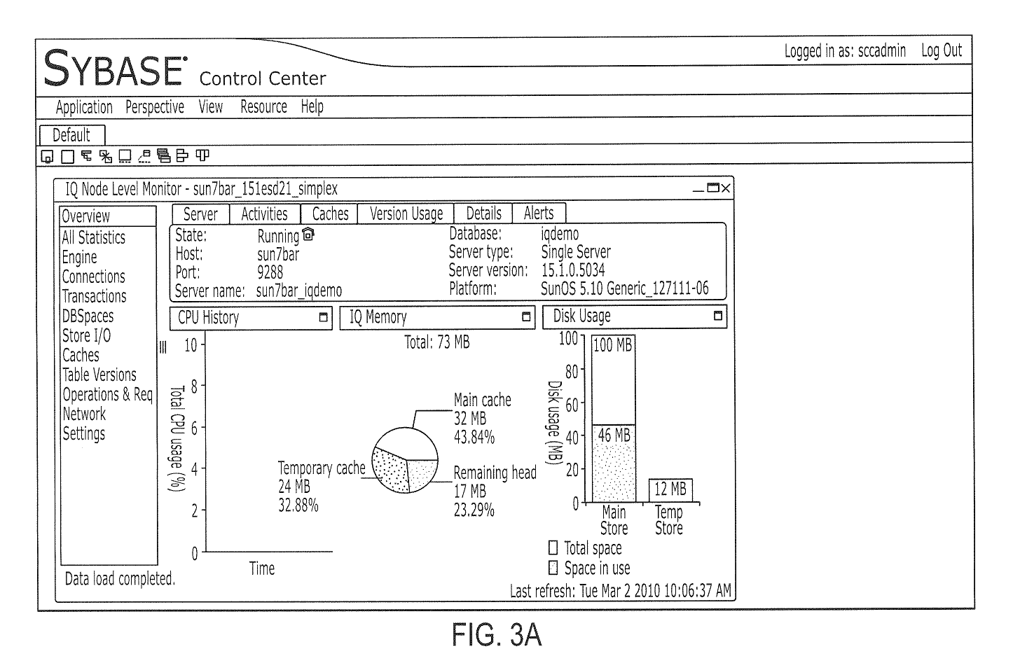

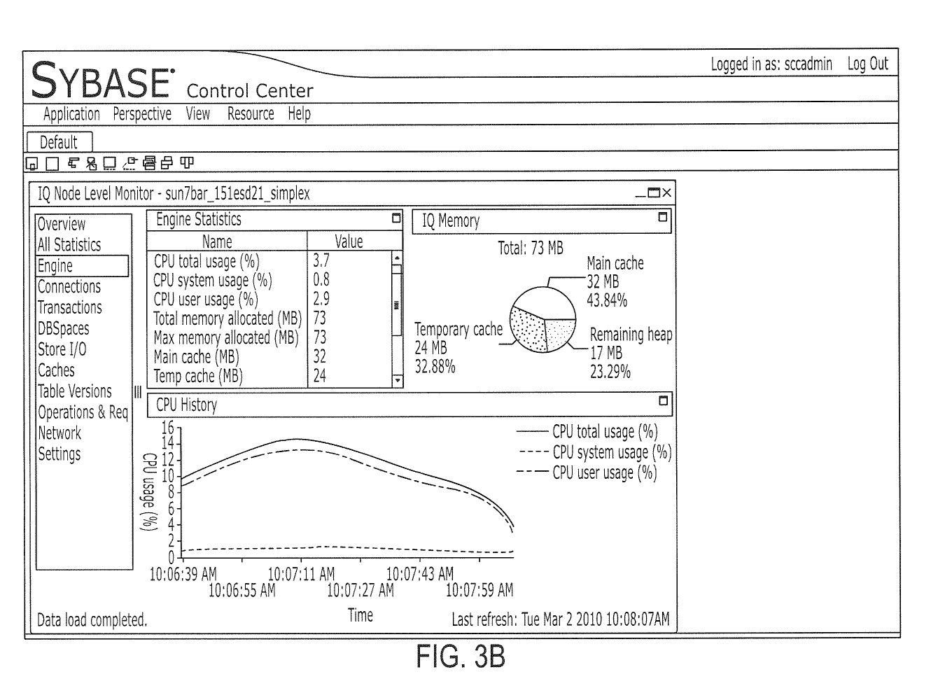

FIG. 3A illustrates an example screen, ‘EngineView’, that is represented by the view component ‘MyView’. In an embodiment of the invention, the same view component, i.e., MyView, can be used to represent the ‘Overview’ user interface screen shown in FIG. 3B. Conventional FLEX coding methods would require that the ‘EngineView’ screen and its behavior be defined together as an inseparable entity. In a similar manner, conventional FLEX coding methods would require that the ‘Overview’ screen its behavior be defined together. In other words, a developer would have to create separate view components for the ‘Overview’ and ‘EngineView’ screens. Thus, a developer would not be able to re-use the ‘MyView’ view component for screens having separate behaviors.

In contrast, as shown in Example 2 below, embodiments of the invention allow the ‘MyView’ view component to be reused for multiple and uniquely behaving user interface screens such as the ‘Overview’ and ‘EngineView’ screens.

Example 2 is exemplary code that can be used by behavior injection module 130 to dynamically inject (and un-inject) a behavior into a view, according to an embodiment. Referring to Example 2, code that appears in line (2.1) is used to by injection determiner 140 to determine if a user interface view called ‘Overview’ has been activated (or displayed) for the first time. If for example, injection determiner 140 determines that a user interface view called ‘Overview’ has been activated for the first time then the code that appears between lines (2.1) and (2.2) is used by behavior injection module 130 to inject a behavior called ‘OverviewBehavior’ into the ‘Overview’ view. In a similar manner, if injection determiner 140 determines that a user interface view called ‘EngineView’ is activated for the first time in using the code in line (2.4), then code that appears between lines (2.4) and (2.5) is used by behavior injection module 130 to inject the behavior ‘EngineBehavior’ into the ‘EngineView’ view. Thus, the ‘MyView’ view component can be re-used for both the ‘Overview’ and ‘EngineView’ views by dynamically injecting their respective behaviors (i.e., OverviewBehavior and EngineBehavior) at runtime.

In this way, embodiments of the present invention separate behavior code from view code, allow re-use of view components, and also enable dynamic (i.e., at runtime) injection and un-injection of one or more behaviors into a view component. In an embodiment, a view component resides in an MXML file, while its behavior code (e.g., ACTIONSCRIPT) is stored in a separate file (e.g., .as file). A view component can be reused in separate applications where different behaviors may be applied to the same view component. In addition, because the behavior code is stored in a separate file, the behavior code is easier to read and maintain.

var view:UIComponent = evt.viewContainer.getChildAt(0) as
UIComponent;
if(view != null){

| // inject behavior into the view | |
|---|---|
| if(evt.toView == NavTreeModel.VIEW_OVERVIEW) | (2.1) |

{

var overview:Overview = view as Overview;
if(overview.behavior == null){

var overviewBehavior : OverviewBehavior = new

OverviewBehavior( );

overviewBehavior.inject(view);

| | |
|---|---|
| } | (2.2) |
| // call onActivated( ) | |
| overview.behavior.onActivated( ); | (2.3) |

}

| | |
|---|---|
| else if(evt.toView = NavTreeModel.VIEW_ENGINE){ | (2.4) |

var engineView:Engine = view as Engine;
if(engineView.behavior == null){

var engineBehavior : EngineBehavior = new
EngineBehavior( );
engineBehavior.inject(view);

| | |
|---|---|
| } | (2.5) |
| // call onActivated( ) | |
| engineView.behavior.onActivated( ); | (2.6) |

}else if(evt.toView ==
NavTreeModel.VIEW_CONNECTIONS){
...
}

}

### Example 2

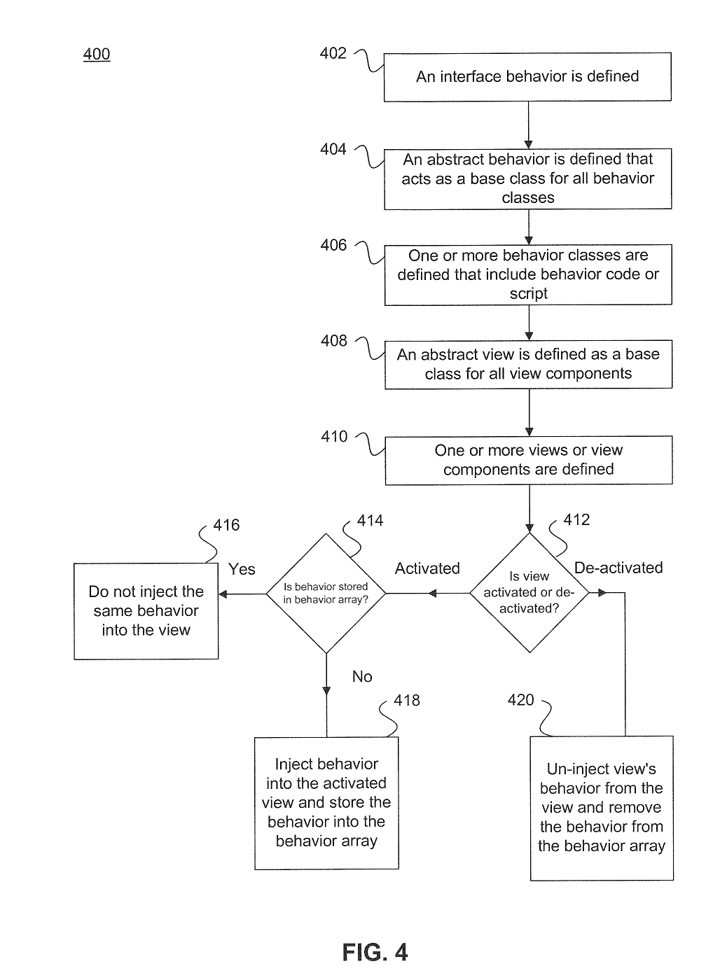

FIG. 4 is a flowchart illustrating an operation of system 100, according to an embodiment.

In step 402, an interface behavior is defined. As discussed above, interface behavior 140 defines interface methods such as inject (view: UIComponent), uninject( ) onActivated( ) and onDeactivated( ). As an example, interface behavior 140 can be implemented as an ‘.as’ file known as ‘IBehavior.as’.

In step 404, an abstract behavior is defined that acts as a base class for behavior classes. In an embodiment, abstract behavior 140 can be implemented as an ‘.as’ file known as ‘AbstractBehavior.as’, which acts as a base class for all behavior classes. As shown in FIG. 1B, abstract behavior 140 contains a member ‘view’, which is set when the ‘inject(view:UIComponent)’ method is called.

In step 406, one or more behavior classes are defined that include behavior code or script. As an example, not intended to limit the invention, such behavior code can be implemented in ACTIONSCRIPT. In an embodiment, if a view component involves a complex behavior, such complex behavior can be divided into several behavior classes, all of which can be injected by behavior injection module 130 into the same view component.

In step 408, an abstract view is defined as a base class for view components. In an embodiment abstract view 170 includes an array of ‘IBehavior’ objects. In an embodiment, when one or more behaviors are injected into a view component by behavior injection module 130, the behaviors are stored in the array of ‘IBehavior’ objects.

In step 410, one or views or view components are defined. As an example, such views and view components are defined using MXML. As an example, the ‘Overview’ view and the ‘EngineView’ view can be defined for the view component ‘MyView’.

In step 412, injection determiner 140 determines if a view associated with a view component has been activated (displayed) or de-activated (hidden from display). As an example, injection determiner 140 can determine if the view ‘Overview’ has been activated.

In step 412, if a view has been activated, injection determiner 140 determines if a behavior for a view that has been activated is already stored in a behavior array (step 414). If injection determiner 140 determines that a behavior to be injected into a view is already stored in the behavior array (step 414), behavior injection module 130 does not inject the same behavior into the view (step 416). On the other hand, if injection determiner 140 determines that a behavior to be injected into a view is not stored in the behavior array (step 414), behavior injection module 130 injects the behavior into the activated view and stores the behavior into the behavior array (step 418).

As an example, when a behavior is injected into a view by behavior injection module 130, it is stored in an array of ‘IBehavior’ objects. Because the behaviors are stored into an array, injection determiner 140 can check the array before behaviors are injected into a view component. Such operation can ensure that no behavior is injected twice into the same view component.

Returning to step 412, if behavior injection engine 130 determines that a view has been destroyed (e.g., removed from memory) behavior injection module 130 un-injects the view's behavior from the view and removes its behavior from the behavior array (step 420).

### Example Computer Embodiment

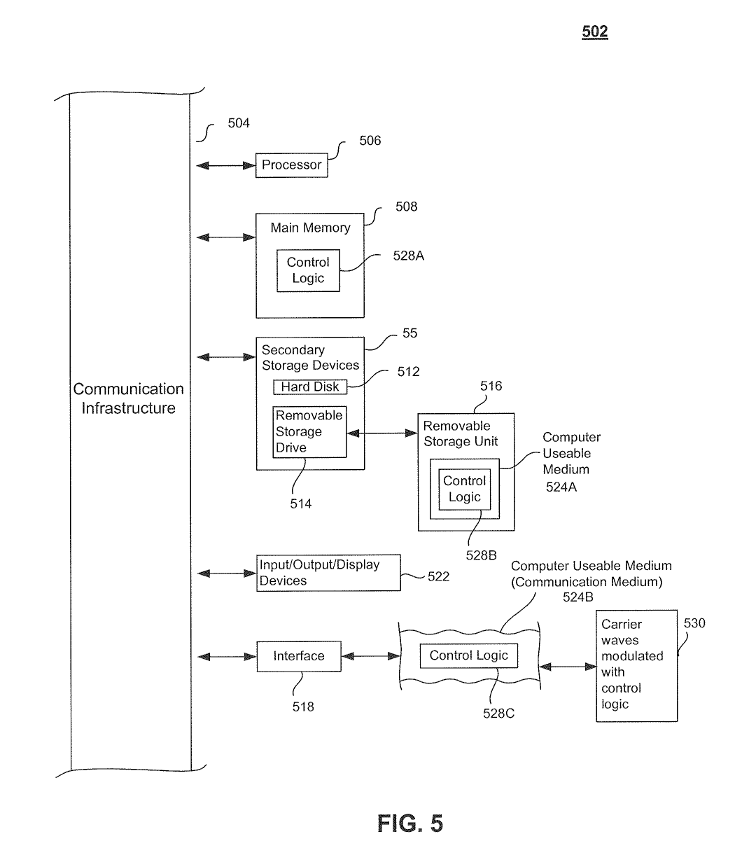

In an embodiment of the present invention, the system and components of embodiments described herein are implemented using well known computers, such as computer 502 shown in FIG. 5. For example, behavior injection module 130 and injection determiner 140 can be implemented using computer(s) 502.

Computer 502 can be any commercially available and well known computer capable of performing the functions described herein, such as computers available from International Business Machines, Apple, Sun, HP, Dell, Compaq, Digital, Cray, etc.

Computer 502 includes one or more processors (also called central processing units, or CPUs), such as a processor 506. The processor 506 is connected to a communication bus 504.

Computer 502 also includes a main or primary memory 508, such as random access memory (RAM). The primary memory 508 has stored therein control logic 528A (computer software), and data.

Computer 502 also includes one or more secondary storage devices 510. The secondary storage devices 510 include, for example, a hard disk drive 512 and/or a removable storage device or drive 514, as well as other types of storage devices, such as memory cards and memory sticks. The removable storage drive 514 represents a floppy disk drive, a magnetic tape drive, a compact disk drive, an optical storage device, tape backup, etc.

Removable storage drive 514 interacts with a removable storage unit 516. The removable storage unit 516 includes a computer useable or readable storage medium 524 having stored therein computer software 528B (control logic) and/or data. Removable storage unit 516 represents a floppy disk, magnetic tape, compact disk, DVD, optical storage disk, or any other computer data storage device. The removable storage drive 514 reads from and/or writes to the removable storage unit 516 in a well known manner.

Computer 502 also includes input/output/display devices 522, such as monitors, keyboards, pointing devices, etc.

Computer 502 further includes a communication or network interface 518. The network interface 518 enables the computer 502 to communicate with remote devices. For example, the network interface 518 allows the computer 502 to communicate over communication networks or mediums 524B (representing a form of a computer useable or readable medium), such as LANs, WANs, the Internet, etc. The network interface 518 may interface with remote sites or networks via wired or wireless connections.

Control logic 528C may be transmitted to and from the computer 502 via the communication medium 524B. More particularly, the computer 502 may receive and transmit carrier waves (electromagnetic signals) modulated with control logic 530 via the communication medium 524B.

Any apparatus or article of manufacture comprising a computer useable or readable medium having control logic (software) stored therein is also referred to herein as a computer program product or program storage device. This includes, but is not limited to, the computer 502, the main memory 508, secondary storage devices 510, the removable storage unit 516 and the carrier waves modulated with control logic 530. Such computer program products, having control logic stored therein that, when executed by one or more data processing devices, cause such data processing devices to operate as described herein, represent embodiments of the invention.

The invention can work with software, hardware, and/or operating system implementations other than those described herein. Any software, hardware, and operating system implementations suitable for performing the functions described herein can be used.

### CONCLUSION

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method for injecting behaviors into view components, comprising:
defining a view component for an application;
defining one or more behaviors for said defined view component;
storing said defined behaviors independently of said view component; and
injecting said behaviors into said view component when said view component is initialized by said application.

2. The method of claim 1, wherein said injecting comprises:
determining if said behaviors are stored in a behavior buffer; and
storing said behaviors into said behavior buffer.

3. The method of claim 1, further comprising:
un-injecting said behaviors from said view component when said view component is removed from memory by said application.

4. The method of claim 3, wherein said un-injecting comprises:
determining if said behaviors are stored in a behavior buffer; and
removing said behaviors from said behavior buffer.

5. The method of claim 1, further comprising:
defining an abstract view as a base class for said view component.

6. The method of claim 1, further comprising:
reusing said defined view component in a different application.

7. The method of claim 1, further comprising:
modifying said defined behaviors independently of said view component; and
injecting said modified behaviors to said view component.

8. A system for injecting behaviors into view components, comprising:
a first module configured to define a view component for an application;
a second module configured to define one or more behaviors for said defined view component;
a third module configured to store said defined behaviors independently of said view component; and
a fourth module configured to inject said behaviors into said view component, when said view component is initialized by said application.

9. The system of claim 8, wherein said view component is defined in Macromedia Extensible Mark-up Language (MXML).

10. The system of claim 8, wherein said behaviors are defined using ACTIONSCRIPT.

11. The system of claim 8, further comprising:
an interface behavior class configured to include one or more interface methods;
an abstract behavior class configured to act as a base class for behavior classes; and
an abstract view configured to store a plurality of behaviors in a behavior buffer, and to act as a base class for said view component.

12. The system of claim 8, wherein said view component is a user interface view.

13. An article of manufacture including a computer-readable medium having instructions stored thereon that, when executed by a computing device, cause said computing device to perform operations comprising:
defining a view component for an application;
defining one or more behaviors for said defined view component;
storing said defined behaviors independently of said view component; and
injecting said behaviors into said view component when said view component is initialized by said application.

14. The article of manufacture of claim 13, said injecting comprising:
determining if said behaviors are stored in a behavior buffer; and
storing said behaviors into said behavior buffer.

15. The article of manufacture of claim 13, said operations further comprising:
un-injecting said behaviors from said view component when said view component is removed from memory by said application.

16. The article of manufacture of claim 15, said un-injecting comprising:
determining if said behaviors are stored in a behavior buffer; and
removing said behaviors from said behavior buffer.

17. The article of manufacture of claim 13, said operations further comprising:
defining an abstract view as a base class for said view component.

18. The article of manufacture of claim 13, said operations further comprising:
reusing said defined view component in a different application.

19. The article of manufacture of claim 13, said operations further comprising:
modifying said defined behaviors independently of said view component; and
injecting said modified behaviors to said view component.
